(19) United States
(12) Patent Application Publication
(10) Pub. No.: US 2021/0216959 A1
(43) Pub. Date: Jul. 15, 2021

(54) DETERMINING PICK UP TIMES FOR ONLINE ORDERS

(71) Applicant: Amazon Technologies, Inc., Seattle, WA (US)

(72) Inventors: Ryan David Hapgood, Cannon Hill (AU); Toby Ian Smith, Woolloongabba (AU); Michael John Neville, Bunya (AU); Lindsey Green, Seattle, WA (US)

(21) Appl. No.: 16/738,800

(22) Filed: Jan. 9, 2020

(51) Int. Cl. G06Q 10/08; G06Q 30/06; H04W 4/021; H04W 4/029

(52) U.S. Cl. CPC G06Q 10/0833; G06Q 10/0836; H04W 4/029; H04W 4/021; G06Q 30/0639

(57) ABSTRACT

A geographical-based fence is established around a store and when an indication is received that a customer is within the geographical-based fence, an estimated time of arrival (ETA) of the customer at the store and/or a time of travel (TOT) of the customer to the store may be determined. Based on the TOT, one or more action(s) may be performed. For example, as the customer comes within a first threshold TOT of the store, a first action may be performed, such as preparing item(s) within the order. As the customer comes within a second threshold TOT of the store, a second action may be performed, such as delivering the one or more items to the customer.

### BACKGROUND

Ecommerce and online shopping has become increasingly popular with the growth of the internet. In some instances, customers may place orders online and then travel to stores to pick up the items included in those orders. Conventionally, customers are given an estimated pick up time or may make educated guesses when their orders are ready for pick up. However, this oftentimes leaves the customers waiting for their orders and/or store associates waiting for the customers to arrive. This delay and uncertainty leads to poor experiences, inconveniences the customers and store associates, and reduces productivity. Furthermore, for certain types of orders, these delays and uncertainties introduce additional challenges. For example, for orders that contain groceries (i.e., food items), there is a risk of refrigerated, frozen, and/or perishable food items spoiling.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference number in different figures indicates similar or identical items. The systems depicted in the accompanying figures are not to scale and components within the figures may be depicted not to scale with each other.

FIG. 1 illustrates an example environment for scheduling a pick up for a customer at a store and/or any other location in which customers may pick up previously ordered items. In some instances, geographical-based fences and/or time-based fence(s) may be utilized to determine an estimated time of arrival (ETA) of the customer at the store and/or a time of travel (TOT) before the customer arrives at the store. Based on entering the geographical-based fences, locations of customers may be determined, and in some instances, based on entering the time-based fence(s), one or more actions may be performed for preparing an order of the customer.

FIG. 2. illustrates an example for utilizing geographical-based fences and/or time-based fences for scheduling the pick up of items. In some instances, as customers cross the geographical-based fences and/or time-based fences, one or more action(s) may be performed for ensuring that orders are prepared for the customers and that the orders are ready for pick up when the customers arrive.

FIG. 3 illustrates an example flow of operations for performing one or more action(s) based on customers crossing the geographical-based fences and/or time-based fences.

FIG. 4 illustrates an example process for determining an ETA and/or a TOT for customers and performing one or more action(s) associated with preparing orders for the customers.

FIG. 5 illustrates an example process for determining an ETA and/or a TOT for customers, tracking the customers, and performing one or more action(s) associated with preparing orders for the customers.

FIG. 6 illustrates an example process for determining whether to track customers for use in determining an ETA and/or a TOT.

FIG. 7 illustrates an example process for determining an ETA and/or a TOT for customers and updating time-based fences.

### DETAILED DESCRIPTION

Online shopping offers customers a great deal of flexibility and may eliminate hassles of parking, walking, locating items, and/or waiting in checkout lines. However, despite these advantages, conventional techniques fail to accurately predict estimated arrival times in an efficient, effective, and commercially viable manner. As a result, customers spend unnecessary time waiting for their orders and/or store associates may spend unnecessary time waiting for customers. Failing to accurately predict arrival times may therefore waste time, contribute to traffic congestion, increase pollution, and in some instances, may spoil items of the order. For example, orders that contain refrigerated, frozen, and/or perishable items may spoil if left outside of a temperature-controlled environment. Providing accurate, timely, and precise pick up times may therefore increase customer satisfaction and convenience, may increase efficiency, and may ensure that certain items (e.g., food items) remain in an optimal state.

In light of the above, this application describes systems and methods for accurately determining pick up times for customers placing online orders. In some instances, accurately predicting pick up times may minimize wait times for customers and/or store associates. For example, after a customer places an order online with a store, store associate(s) may locate and pick item(s) to fulfill the order. In the meantime, the customer may be tracked or monitored for use in determining an estimated time of arrival (ETA). For example, using a mobile device of the customer, a location of the customer may be monitored. In some instances, the customer may first opt-in for having their location or other traveling information (e.g., speed, direction) determined. Upon determining that the customer is about to arrive at the store, the store associate(s) may prepare the order for delivery to the customer. Customers may therefore conveniently pick up orders without having to wait for the store associate(s) and/or the store associate(s) may avoid waiting for customers. Such process may increase a productivity of the store associate(s) and/or customers and reduce wait times.

In some instances, monitoring customers may involve establishing one or more virtual fences or geographical-based fences (e.g., geofence) around a store. The geographical-based fences may provide information about a distance between the customers and the store. By way of example, a geographical-based fence may be established (e.g., set) around a ten-mile radius of the store. As customers travel to the store, a notification may be triggered upon the customers entering the geographical-based fence (e.g., the mobile device of the customer may transmit the notification). A global positioning system (GPS) or other techniques, such as triangulation, may be used to determine that the customer (or the mobile device) is within the geographical-based fence. This notification may serve as an indication that the customer is within a certain distance (e.g., threshold distance) of the store. For example, continuing with the above example, the indication may signify that the customer is ten miles from the store.

In some instances, receiving the notification may cause one or more actions to be performed. For example, store associate(s) may begin collecting items to fulfill the orders. In some instances, and as noted above, multiple geographical-based fences may be established around the store and each of the geographical-based fences may be associated with respective action(s). For example, upon the customer entering a first geographical-based fence, a first action may be performed, such as collecting non-perishable item(s) within the order (e.g., cereal, bread, sugar, etc.). Upon the customer entering a second geographical-based fence, a second action may be performed, such as collecting perishable item(s) within the order (e.g., frozen items, refrigerated items, meat, etc.). It is also contemplated that different actions may be performed as a result of the customer entering, or being within, different time-based fences, as described herein. Additionally, or alternatively, determining that the customers are within the geographical-based fence may involve store associate(s) pulling or locating the orders within the holding areas for delivery to the customers.

In some instances, upon determining that the customers are within the geographical-based fence, an ETA of the customer may be calculated. For example, knowing the location of the customers within the geographical-based fence and the location of the store, an ETA of the customer to the store may be calculated. Generally, the ETA may indicate a proximity of the customer to the store. The distance of the customer from the store may therefore be used to determine a predicted time the customer is set to arrive at the store. In some instances, the ETA may also be determined using information about traffic, information about road and/or pedestrian networks around the store, time of day, and so forth. In some instances, the device of the customer may transmit location information or tracking information to determine the ETA.

After determining the ETA, a time of travel (TOT) may be calculated. The TOT may represent an amount of time it takes for the customers to travel to the store for their current location. For example, knowing the ETA may be used to determine the TOT between the customer (via the customer entering the geographical-based fence) and the location of the store. In some instances, a countdown may begin associated with a TOT and when the TOT is less than a threshold time, one or more actions may be performed. For example, store associate(s) may begin collecting item(s) within the order and/or may prepare the orders for delivery to the customers.

In some instances, store associate(s) may deliver the orders to designated pick up locations around the store. The designated pick up locations, by way of example, may resemble delivery bay(s), parking space(s), drive-thru(s), curb-side location(s), and so forth. Additionally, or alternatively, the orders may be placed in lockers or cubbyholes outside of the store. Accordingly, when the customers are within a certain time of travel to the store, store associate(s) may transport the orders to the customers at the designated pick up locations.

Additionally, or alternatively, within the geographical-based fence(s), the customer may be monitored or otherwise tracked for continuously determining the ETA and the TOT. For example, rather than determining a single estimated ETA at a particular instance in time, the ETA may be continuously updated for use in determining an updated TOT. However, knowing that the customer is a certain distance away from the store (e.g., based on entering the geographical-based fence), in some instances, may not account for road networks, traffic, speed, acceleration, or which direction the customers are approaching the store. However, such characteristics may impact the ETA of the customers at the store. Accordingly, in some instances, tracking information, such as coordinates (e.g., longitude and latitude), a direction of travel, acceleration, speed, and so forth may be continuously received from the device of the customer for use in continuously updating the ETA and/or the TOT between the customer and the store. Such updating may provide an accurate ETA and the TOT to lessen wait times of the customer and/or store associate(s). In some instances, the ETA and the TOT may be calculated for the customer upon receiving the notification that the customer is within the geographical-based fence.

In some instances, virtual time-based fences may be established around the store and represent estimates of travel times for customers to the store. Each time-based fence, therefore, may represent a time of travel to the store or a threshold or certain TOT. In some instances, the time-based fences may be referred to “chronofences” or fences that are established at locations around the store based on an estimated amount of time it takes to travel to the store. As customers cross, enter, or come within these time-based fences, different actions may be performed. For example, by tracking the customer, as the customer enters within respective time-based fences, or comes within a certain threshold TOT of the store, indications may be provided to the store associate(s) for performing one or more actions. That is, the TOT to be compared against the time-based fences to allow store associates to better plan and manage customer orders. By way of example, when the customers enter a time-based fence that is associated with a TOT that is ten minutes away (e.g., when the customer is ten minutes away), the order of the customer may be prepared, and subsequently, when the customers enter a time-based fence that is one-minute away (e.g., when the customer is one minute away), the store associate(s) may transport the orders to the designated pick up locations.

The time-based fences may therefore be utilized when the customers are within the geographical-based fence and once inside the geographical-based fence, a real-time tracking session may be implemented. In some instances, the customer may be tracked within the geographical-based fence to conserve a battery of the device of the customer. Herein, the real-time tracking session may continuously receive the tracking information of the customer for use in determining the ETA and the TOT. In some instances, the device of the customer may transmit tracking information on a continuous basis or pre-scheduled basis, such as every, five, ten, or fifteen seconds. However, in some instances, if the customer is still far from the store (e.g., greater than a threshold distance or time from the store), then a high-level accuracy of the ETA and/or the TOT may not be needed. As the customer approaches the store and gets closer, higher-level accuracy may be needed and more frequent updates may be received to more accurately determine the ETA and/or the TOT. Additionally, or alternatively, several geographical-based fences may be established around the store and each time the device of the customer enters within a different geographical-based fence, the device of the customer may transmit the tracking information. In some instances, a size of the geographical-based fence(s) may be based at least in part on a size or area encompassed by the time-based fence(s). For example, once the time-based fence(s) are established (i.e., an amount of time from the store for triggering certain action(s)), a geographical-based fence may be identified which encompasses the time-based fence(s). In some instances, the geographical-based fences may be established at a certain offset or threshold distance from the time-based fence(s) (e.g., 100 feet, one mile, etc., outside the perimeter defined by the time-based fence).

Determining the ETA and the TOT of customers may therefore involve various techniques. For example, in some instances, at a first instance a first technique, such as geographical-based fences, may be utilized to determine that the customer is within a certain distance of the store. Therein, at a second instance, or over a second period of time, a second technique, such as time-based fences, may be used to determine the ETA and the TOT of the customer. In some instances, the second technique may be utilized upon receiving a notification that the customer is within the certain distance of the store. At the second instance, upon determining that the TOT is under or at a second threshold or the customer is within a certain time of the store (e.g., one minute), the store associate(s) may be instructed to deliver the order to the customer.

To illustrate, envision that a customer placed an order online for pick up at a store using his or her device (e.g., phone, tablet, etc.). An order notification is transmitted to the store, which inserts the order into a preparation queue for preparing the order. In some instances, the notification may identify a physical location of the store at which the customer is to pick up one or more item(s). As part of this process, a geographical-based fence may be established around the store. Additionally, notification may be sent to the device of the customer to transmit a notification when the device is within the geographical-based fence. Outside the geographical-based fence, or when the customer is more than a certain distance away from the store, the customer may not be monitored. However, upon receiving an indication that the customer is within the geographical-based fence, via the device, the customer may be monitored. In some instances, monitoring the customer may involve receiving tracking information (e.g., bearing, coordinates, speed, acceleration, etc.) associated with the customer. In some instances, an accuracy of the tracking information may also be received (e.g., accuracy of coordinates). This information may be combined with traffic information, information about a road network around the store for use in determining the ETA and the TOT. Additionally, in some instances, when the customer enters the geographical-based fence, a notification may be sent to notify the store (or store associate(s)) that the customer is nearby and to prepare the order. For example, store associate(s) may locate item(s) within the store to complete the order. In some instances, after fulfilling the order, the store associate(s) may place the orders in a holding area (e.g., shelves, freezers, refrigerators, etc.) while awaiting pick up or may directly deliver the order to the customer. Within the geographical-based fence, however, the customer is continuously monitored and the ETA and TOT may be updated. Once the customer is within a threshold TOT (e.g., when the TOT is within a time-based fence), store associate(s) may bring the order of the customer to the designated pick up locations. Within the geographical-based fence, the customer may be continuously monitored for use in determining whether the customer is within the threshold TOT, and if so, one or more actions may be performed (e.g., delivering the order to the customer). As such, in some instances, continuously tracking the customer within the geographical-based fence may reduce customer and/or store associate wait times when picking up orders.

In some instances, customers may opt-in for having their location determined and tracked via their devices and once within the geographical-based fence(s). For example, as part of enrolling in a service for online ordering at the store, or at a first instance, customers may opt-in and select whether to have their location monitored. As discussed above, opting-in may allow the customer to be tracked, on a real-time basis, for use in determining the ETA and/or the TOT. In some instances, opting-in may permit the location of the customer to be tracked only within the geographical-based fence. Moreover, in some instances, after exiting the geographical-based fence, picking up the order, and/or if the order is cancelled, the customer may not be tracked. As such, the tracking the customer may be carried out in instances where the customer has granted permission.

In some instances, the customer may be tracked without customer involvement and after opting-in. For example, upon placing an order, a location component on the customer device may be activated and may transmit an indication upon entering the geographical-based fence. Therein, location and/or other tracking information may be continuously received for determining the ETA and the TOT between the location of customer and the location of the store. As such, an experience of the customer may be seamless with little to no involvement.

Accordingly, discussed herein are techniques for reducing wait times for customers picking up order by accurately predicting ETAs and/or TOT. In some instances, determining the ETAs and/or TOT may utilize various techniques, such as geographical-based fences and time-based fences. In some instances, within the geographical-based fences, the customer may be continuously monitored for use in updating the ETAs and/or the TOT. Based on the ETA and/or the TOT, one or more actions may be triggered. For example, when the customers are within time-based fences that are associated with a TOT, store associates may deliver the orders to the customer. Accordingly, the TOT may, in some instances, be compared against a threshold for performing or more actions. Such on-time delivery may increase customer satisfaction and experiences, reduce wait times, increase productivity, and/or decrease pollution.

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment, or instance, may be combined with the features of other embodiments or instances. Such modifications and variations are intended to be included within the scope of the disclosure and appended claims.

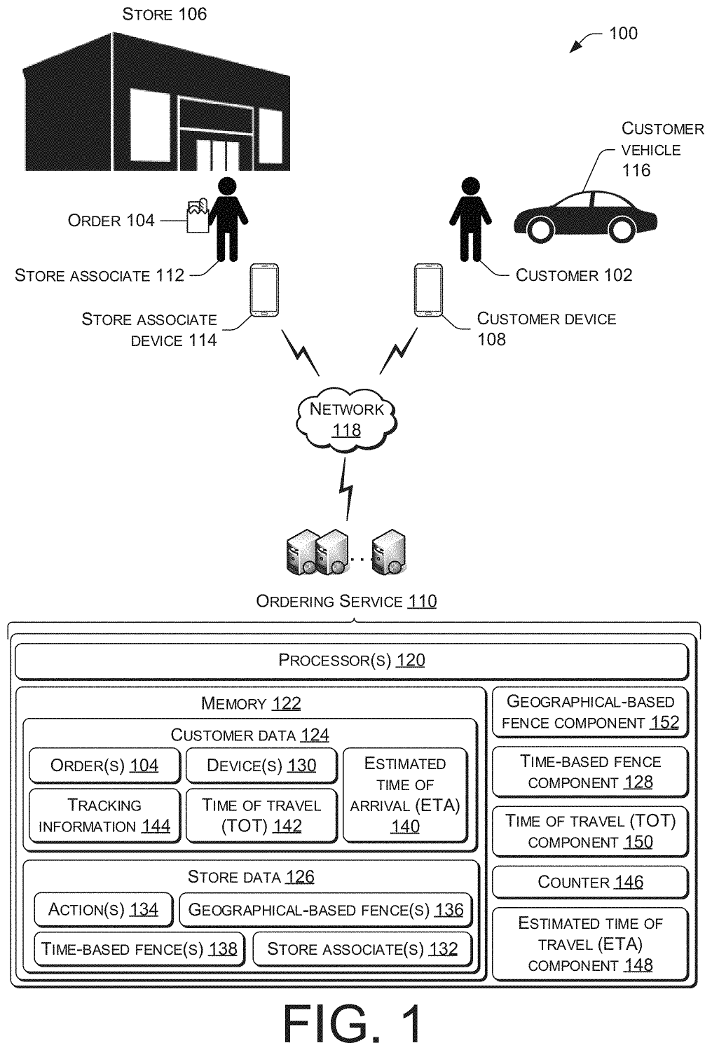

FIG. 1 illustrates an example environment 100 for delivering orders to customers at pick up locations, and based on determining an estimated time of arrival (ETA) and/or a time of travel (TOT). In some instances, the customers may travel to the pick up locations after placing orders online. For example, a customer 102 may place an order 104 for one or more item(s) at a store 106. However, although FIG. 1 illustrates a particular customer placing and picking up a particular order (e.g., the customer 102 placing the order 104), as referred to herein “customers 102” may place orders, respectively, at the store 106 and/or different stores.

In some instances, the store 106 may represent a retailer or merchant selling item(s), goods, and/or services. As discussed herein, by way of example and not limitation, the store 106 may represent a grocery store selling groceries (e.g., dairy, fruit, vegetables, canned goods, etc.) and/or other household goods (e.g., toiletries, utensils, etc.). The store 106 may also include any physical location at which the customers 102 may pick up previously ordered or purchased items. The store 106 may maintain item(s) that the customers 102 are able to order or, upon the customers 102 placing the orders, the item(s) included in the orders may be provided to the stores for subsequent pick up by the customer 102. For example, the store 106 may maintain inventory for fulfilling the order 104, or after the order 104 is prepared and fulfilled at an offsite location, the order 104 may arrive at the store 106 for pick up by the customer 102.

In some instances, the customer 102 may place the order 104 using a customer device 108, where the order 104 includes item(s) that are offered by a service provider and that are purchased by the customer 102. The customer 102 may place the order via a website associated with the service provider or via a mobile application that is associated with the service provider and that resides on the customer device 108. In some instances, the customer 102 may interact with the customer device 108 to place item(s) within a virtual shopping cart. The virtual shopping cart may be associated with a customer account or profile of the customer 102 that is maintained by the service provider. The customer 102 may purchase the item(s) within the shopping cart and the order 104 may be created. An order notification may be transmitted to an ordering service 110 that coordinates the fulfillment of the order 104 at the store 106. The order 104 of the customer 102 may be placed into a preparation queue for preparing the order 104, along with the orders of other customers. For example, after placing the order 104, a store associate 112 of the store 106 may locate (e.g., pick) the items within the order 104 and prepare the order 104 for the customer 102.

In some instances, a store associate device 114 may display the tasks of the store associate 112. For example, the store associate device 114 may indicate the order 104 of the customer 102, the item(s) of the order 104, the location of the item(s) within the store 106, and so forth. The store associate 112 may therefore utilize the store associate device 114 for fulfilling, completing, or preparing the order 104.

After preparing the order 104, the store associate 112 may deliver the order 104 to the customer 102 at designated pick up locations inside and/or outside the store 106. In some instances, the designated pick up locations may resemble parking spaces within a parking lot of the store 106, parking spaces outside an entry of the store 106 (e.g., curb-side pick up), a delivery bay at the store 106, a drive-thru at the store 106, and so forth. In some instances, the customer 102 may travel to the store 106 using various modes of transportation, such as public transportation (e.g., ferry, bus, etc.) or private transportation (e.g., car, bicycle, walking, etc.). As shown in FIG. 1, in some instances, the customer 102 may utilize a customer vehicle 116 to travel to the store 106 to pick up and receive the order 104. Regardless, upon arriving at the store 106, the store associate 112 may deliver the order 104 to the customer 102 at the designated pick up locations. In some instances, the customer 102 may remain in the customer vehicle 116 while the store associate 112 delivers the order 104 or the customer 102 may exit the customer vehicle 116 to receive the order 104 from the store associate 112. After picking up the order 104, the store associate 112 may return to fulfilling additional orders and the customer 102 may leave with the items included in the order 104.

In some instances, the preparation and pick up of the order 104 may be administered, controlled, and/or coordinated at least in part by the ordering service 110. The ordering service 110 may attempt to limit an amount of time the customer 102 waits for the store associate 112 to deliver the order 104 and/or an amount of time the store associate 112 waits for the customer 102 to arrive at the store 106. For example, in instances where the store associate 112 waits for the customer 102 to arrive, item(s) within the order 104 may spoil (e.g., frozen items, refrigerated, items, perishable items, etc.). Waiting for the customer 102 may also reduce a productivity of the store associate 112 fulfilling additional orders of other customers. Additionally, or alternatively, in instances where the customer 102 waits for the store associate 112, the customer 102 may become frustrated and impatient. Traffic around the designated pick up locations and/or the store 106 may also increase. Accordingly, to increase experiences of both the customer 102 and the store associate 112, and to increase productivity, the ordering service 110 may coordinate the delivery of the order 104 to the customer 102 in an on-time and efficient manner.

The ordering service 110 may include a computing system, various modules, components, data stores, and the like. In some instances, the ordering service 110 may be implemented as one or more servers and may, in some instances, form a portion of a network-accessible computing platform implemented as a computing infrastructure of processors, storage, software, data access, and so forth that is maintained and accessible via a network 118, such as the Internet. The ordering service 110 does not require end-user knowledge of the physical location and configuration of the system that delivers the services. Common expressions associated with these one or more servers may include “on-demand computing,” “software as a service (SaaS),” “platform computing,” “network-accessible platform,” “cloud services,” “data centers,” and so forth.

As shown in FIG. 1, the ordering service 110 may include processor(s) 120 and memory 122. The processor(s) 120 may carry out or otherwise perform operations associated with coordinating the delivery of the order 104. Additionally, the ordering service 110 may communicatively couple to the customer device 108 and/or the store associate device 114 via or over the network 118. The network 118 may communicatively couple the customer device 108, the store associate device 114, and/or the ordering service 110 using wireless technologies (e.g., RF, cellular, satellite, Bluetooth, etc.), or other connection technologies.

The memory 122 may store data or otherwise have access to information for coordinating the delivery of the order 104 at the pick up location(s). For example, as shown, the memory 122 may store or otherwise have access to customer data 124 and store data 126. The customer data 124 may include order(s) 104 of the customers 102, respectively (e.g., the order 104 of the customer 102). The customer data 124 may include and maintain the order(s) 104 for the customers 102 (e.g., shopping and/or purchase history) for carrying out the fulfillment and preparation of the order(s) 104 of the respective customers 102. In some instances, the ordering service 110 may utilize the customer data 124 to identify the customers 102 and the order(s) 104 of the customers 102, respectively. For example, knowing the order(s) 104 of the customers 102, the ordering service 110 may coordinate the pick up of the order(s) 104 of the customers 102, respectively, across various stores.

The customer data 124 is further illustrated including device(s) 130 or data of the devices of the customers 102 (e.g., device identifier). As discussed herein, the device(s) 130 may be used for monitoring or tracking the customers 102 (e.g., the customer 102) to coordinate the pick up of the orders 104. In some instances, the customer 102 may first opt-in before being monitored or tracked. The device(s) 130 may be stored in association with the respective customers 102 (e.g., within the customer data 124) to identify which device(s) 130 are associated with the customers 102, vice versa. Accordingly, for each of the customers 102, the ordering service 110 may utilize the order(s) 104 and the device(s) 130 for preparing the order(s) 104 and ensuring an on-time pick up of the order(s) 104 for the respective customers 102.

The store data 126 may include various information about stores the ordering service 110 coordinates with to fulfill the order(s) 104. The ordering service 110, for example, may be utilized by stores for preparing and fulfilling the order(s) 104. In this sense, the ordering service 110 may offer a service that is utilized or offered to the stores for preparing and fulfilling the order(s) 104. For example, the store data 126 may identify information about the stores, such as location (e.g., physical location, coordinates, etc.), inventory, operating hours, and so forth. Additionally, the store data 126 may include store associate(s) 132 and/or action(s) 134. For example, upon receiving an indication of the order 104, the ordering service 110 may identify a store to fulfill the order 104, such as the store 106. In identifying the store 106 (e.g., the store with which the order 104 is placed and/or to be picked up), the ordering service 110 may instruct the store associate 112 among the store associate(s) 132 for fulfilling the order 104. The store associate(s) 132 may each be associated with respective stores such that the ordering service 110 may select the store associate 112 for fulfilling the order 104, based at least in part on determining that the store associate 112 works at the store 106. Information about the stores and the store associate(s) 132 may therefore permit the ordering service 110 to select store associates for fulfilling the order(s) 104.

The action(s) 134 may correspond to actions or tasks performable by the store associate(s) 132. In some instances, the action(s) 134 may include picking one or more item(s) within the store 106 to prepare the order 104, storing the order 104 within a holding area of the store 106 (e.g., while waiting for the customers 102), removing the order 104 from the holding area (e.g., when the customer 102 is nearby), delivering the order 104 to the customer 102 at the designated pick up locations, and/or returning the order 104 to the holding area (e.g., where the customer 102 is late arriving or did not arrive). The store associate 112 may be instructed about which action among the action(s) 134 to perform. For example, the ordering service 110 may transmit an indication of the action to the store associate device 114, which may display or otherwise indicate the action. Therein, the store associate(s) 132 may perform the instructed action and interface with the store associate device 114 to indicate the completion of the action and/or a current progress of the order(s) 104. For example, the store associate 112 may deliver the item(s) included in the order 104 to the customer 102.

The ordering service 110 may utilize various techniques for accurately determining the arrival time of the customer 102 at the store 106. As discussed above, accurately predicting or determining the arrival time of the customer 102, or a travel time of the customer 102 to the store 106, may reduce an amount of time the customer 102 waits for the store associate 112 and/or an amount of time the store associate 112 waits for the customer 102. In some instances, the ordering service 110 may utilize virtual fences, such as geographical-based fence(s) 136 and/or time-based fence(s) 138, for determining when the customer 102 will arrive at the store 106. The geographical-based fence(s) 136 and/or the time-based fence(s) 138 may be utilized for performing the action(s) 134. For example, the geographical-based fence(s) 136 may represent geofences that when breached or entered within, trigger one or more actions (e.g., the action(s) 134). In some instances, the geographical-based fence(s) 136 may be established around a perimeter of the store 106 or a radius (or certain distance) around the store 106. That is, when the customer 102 is within a threshold or certain distance of the store 106 (e.g., within the geographical-based fence(s) 136), events may be triggered. By way of example, the geographical-based fence(s) 136 may include a radius of a quarter, one, five, or ten miles around the store 106. In some instances, multiple geographical-based fence(s) 136 may be established around respective stores, or stores may include multiple geographical-based fence(s) 136.

In some instances, upon entering the geographical-based fence(s) 136, the ordering service 110 may begin monitoring the customer 102 via the customer device 108. For example, as part of placing the order 104, the customer 102 may permit the ordering service 110 to monitor or track the customer 102 within the geographical-based fence(s) 136. Here, upon the customer device 108 entering the geographical-based fence(s) 136, the customer device 108 may transmit an indication to the ordering service 110. The indication may notify the ordering service 110 that the customer 102 is within the geographical-based fence(s) 136. Such indication may be utilized to determine how far (e.g., distance) the customer 102 is from the store 106. That is, knowing the size or radius of the geographical-based fence(s), the ordering service 110 may determine that the customer 102 is five miles from the store 106. In some instances, the ordering service 110 may await or be on the lookout for the customer device 108 within the geographical-based fence(s) 136 based on the customer 102 placing the order 104. In some instances, upon receiving the notification that the customer 102 is within the geographical-based fence(s) 136, the ordering service 110 may cause the action(s) 134 to be performed. For example, the ordering service 110 may instruct the store associate 112 to locate the item(s) of the order 104.

In some instances, the customer device 108 may utilize one or more location techniques, components, and/or methods for determining that the customer device 108 is within the geographical-based fence(s) 136. For example, the customer device 108 may include a global positioning system (GPS) component. When the customer device 108 determines that the GPS coordinates of the customer device 108 are within GPS coordinates associated with the geographical-based fence(s) 136, the customer device 108 may transmit the indication notifying the ordering service 110 that the customer device 108 is within the geographical-based fence(s) 136. In some instances, the GPS coordinates may be associated with an accuracy (e.g., how accurate the GPS coordinates are to the actual location). However, the customer device 108 may utilize other techniques, such as triangulation, application(s) on the customer device 108, Wi-Fi access points, inertial sensor(s) (e.g., compass, magnetometer, accelerometer, gyroscope, etc.), Bluetooth beacons, and so forth for determining that the customer device 108 is within the geographical-based fence(s) 136. In other embodiments, the customer 102 may explicitly provide his/her current location to the ordering service 110 via the customer device 108. In some instances, the ordering service 110 (or other service/system) may determine a current location of the customer device 108 and subsequently determine a distance between the current location and the store 106. Therein, the ordering service 110 (or other service/system) may determine whether the customer 102 is outside or within a particular geographical-based fence based on the determined distance.

In some instances, the geographical-based fence(s) 136 may be set at a certain distance from the store 106 that permits the store associate 112 to prepare and fulfill the order 104. For example, each of the store(s) utilizing the ordering service 110 may include, or be associated with, respective geographical-based fence(s) 136. In other words, the geographical-based fence(s) 136 may be stored in association with the stores. Upon the order 104 being placed, the ordering service 110 may determine or set, for the respective store(s), the associated geographical-based fence(s) 136. The geographical-based fence(s) 136, noted above, may trigger certain events or action(s) 134. For example, based on a distance between the customer 102 and the store 106 (e.g., five miles), the ordering service 110 may instruct the store associate 112 to perform an action (e.g., prepare the order 104).

Additionally, upon receiving the notification that the customer 102 is within the geographical-based fence(s) 136, the ordering service 110 may determine an estimated time of arrival (ETA) 140. In some instances, the ordering service 110 may determine the ETA 140 for use in determining when the customer 102 is expected to arrive at the store 106. That is, knowing how far (e.g., distance) the customer 102 is from the store (e.g., upon entering the geographical-based fence(s) 136) may not indicate an amount of time before the customer 102 arrives at the store 106 for instructing the store associate 112 to deliver the order 104 to the pick up locations. In some instances, determining the ETA 140 may involve taking into consideration a road network, traffic, time of day, direction of travel, and so forth. Utilizing this information, in addition to the distance of the customer 102 from the store 106 (e.g., via the geographical-based fence(s) 136 and/or GPS), may more accurately predict the time of arrival, or the ETA 140, for use in instructing the store associate 112 to prepare the order 104 and/or deliver the order 104 to the customer 102. For example, depending on the direction of travel of the customer 102 to the store 106, it may take the customer 102 a greater amount of time to reach the store 106 if traveling from the east as compared to the west. Traveling from the east, for example, may include less traffic than if the customer 102 approaches the store 106 from the west. As such, determining the time it takes for the customer 102 to reach the store 106 may reduce wait times of the customer 102 and/or the store associate(s) 132. In some instances, if the ETA 140 of the customer 102 is within a threshold ETA, one or more of the action(s) 134 may be performed.

The ETA 140 of the customer 102 may be utilized to determine a time of travel (TOT) 142. The TOT 142 may represent an estimated amount of time it will take for the customer 102 to travel to the store 106. For example, knowing the ETA 140 may be used to determine the TOT 142 between the customer 102 (via the customer 102 entering the geographical-based fence(s) 136) and the location of the store 106. That is, although the ETA 140 indicates the predicted arrival time of the customer 102, the TOT 142 may serve as a countdown for determining how long before the customer 102 is predicted to reach the store 106. In some instances, and as shown, a counter 146 of the ordering service 110 may utilize the TOT 142 for triggering one or more of the action(s) 134 based on the TOT 142 being less than certain threshold times. For example, in addition to utilizing the geographical-based fence(s) 136, the time-based fence(s) 138 may be established around the store 106. The time-based fence(s) 138 established around the store 106 may represent estimates of travel times for the customer 102 to the store 106. As the customer 102 crosses these time-based fence(s) 138, different action(s) 134 may be performed. Generally, the time-based fence(s) 138 may be associated with a time threshold and when the TOT 142 of the customer 102 comes within the time-based fence(s) 138, action(s) 134 may be triggered. In this sense, if the TOT 142 is within a certain time corresponding to the time-based fence(s) 138, the action(s) 134 may be performed.

For example, upon the customer 102 entering the geographical-based fence(s) 136, the ordering service 110 may receive tracking information 144 from the customer device 108. As discussed herein, the customer 102 may opt-in to permit the customer device 108 to send, and the ordering service 110 to receive, the tracking information 144. In some instances, the tracking information 144, may include location and/or GPS coordinates (e.g., longitude and latitude), a direction of travel, acceleration, speed, etc. of the customer device 108. The tracking information 144 may be utilized to determine the ETA 140 and/or the TOT 142. For example, based on the tracking information 144, the ordering service 110 may determine a route of the customer 102, a direction of travel of the customer 102, traffic surrounding the customer 102, and/or a speed of the customer 102. These factors may impact the ETA 140 and the TOT 142 of the customer 102 to the store 106. In some instances, the ordering service 110 may determine the ETA 140 and/or the TOT 142, or the ordering service 110 may utilize one or more third-party service(s) for determining the ETA 140 and/or the TOT 142.

By tracking the customer 102, the ordering service 110 may have a better indication or more accurate prediction of when the customer 102 will arrive at the store 106. This increase in accuracy may limit wait times of the customer 102 and/or the store associate112. In some instances, as the customer 102 enters within respective time-based fence(s) 138, indications may be provided to the store associate 112 for performing one or more of the action(s) 134. As shown, the time-based fence(s) 138 may be stored in association with the store data 126, as the time-based fence(s) 138 may be dependent on the store 106 fulfilling the order 104 (e.g., road network, accessibility, etc.). Additionally, or alternatively, the time-based fence(s) 138 may be dependent on the order 104 of the customer 102 (e.g., how many item(s) are within the order 104) and/or a time of day the customer 102 is picking up the order 104 (e.g., traffic). Accordingly, knowing the TOT 142 allows the store associate 112 to better plan and manage the order 104.

By way of example, a first time-based fence may be established at ten-minutes away from the store 106. When the TOT 142 of the customer 102 is less than ten-minutes, the customer 102 may be considered with the first time-based fence and the ordering service 110 may trigger an event or action among the action(s) 134. For example, upon the TOT 142 being within the first time-based fence (or a first threshold of time), the store associate 112 may be instructed to prepare the order 104 of the customer 102. When the customer 102 enters a second time-based fence, for example, that is established one-minute away from the store 106, the store associate 112 may be instructed to transport the order 104 to the designated pick up locations. The time-based fence(s) 138 may represent fences in the sense that around the store 106, a virtual fence is established and when the TOT 142 is within or less than the time associated with fence, the action(s) 134 may be triggered.

As discussed above, and in some instances, the ordering service 110 may continuously receive the tracking information 144 for determining the ETA 140 and/or the TOT 142, and/or the ordering service 110 may transmit (e.g., forward) the tracking information 144 to one or more third-party service(s) for determining the ETA 140 and/or the TOT 142. Additionally, or alternatively, in some instances the ETA 140 and/or the TOT 142 may be determined at a single instance and the counter 146 of the ordering service 110 may compare the ETA 140 and/or the TOT 142 to the time-based fence(s) 138 (or threshold(s)) for use in performing the action(s) 134.

As shown, in some instances, the ordering service 110 may include an estimated time of travel (ETA) component 148 and/or a time of travel (TOT) component 150 that determines the ETA 140 and/or the TOT 142, respectively, on a singular or continuous basis. Such components, however, may be included within the third-party service(s) for determining the ETA 140 and/or the TOT 142, and the ETA 140 and/or the TOT 142 may then be transmitted back to the ordering service 110. In such instances, the ordering service 110 may utilize the ETA 140 and/or the TOT 142 for performing or triggering the action(s) 134.

The ordering service 110 may also include a geographical-based fence component 152 and/or a time-based fence component 128. The geographical-based fence component 152 may select, set, or determine the geographical-based fence(s) 136 for the store 106 and based receiving the order(s) 104 of the customers 102. For example, depending on the order 104 (e.g., item(s) of the order 104, the store 106, the area in which the store 106 is located (e.g., densely populated, suburban, rural, etc.), and/or the customer 102, the geographical-based fence component 152 may determine a size of the geographical-based fence(s) 136. Such characteristics, for example, may impact an amount of time at which the ordering service 110 notifies the store associate(s) 132 for performing the action(s) 134 or when the store 106 need to determine the TOT 142 for ensure that the order 104 is prepared for the customer 102. However, in some instances, the geographical-based fence(s) 136 may be set or selected from preconfigured or predetermined geographical-based fence(s) of a certain size and/or shape.

The time-based fence component 128 may similarly determine the time-based fence(s) 138 around the store 106, or what time-based fence(s) 138 to establish or utilize for triggering the one or more action(s) 134. For example, depending on the order 104, the store 106, the area in which the store 106 is located, the customer 102, and/or the tracking information 144, the time-based fence component 128 may select or determine time-based fence(s) 138 for when to notify the store associate(s) 132 for performing the action(s) 134. In this sense, for each of the order(s) 104 of the customers 102, the time-based fence component 128 may select one or more time-based fence(s) 138 for comparison to the TOT 142. As the customers 102 TOT 142 is determined, in instances where the TOT 142 is less than the TOT associated with each of the time-based fence(s) 138, corresponding action(s) 134 may be performed. For example, for the order 104 of the customer 102, the time-based fence component 128 may select time-based fences of five minutes and one minute. For the first time-based fence (e.g., five minutes), when the TOT 142 is less than five minutes, the store associate 112 may gather item(s) within the order 104. For the second time-based fence (e.g., one minute), when the TOT 142 is less than or equal to one minute, the store associate 112 may deliver the order 104 to the pick up location. The geographical-based fence(s) 136 and/or the time-based fence(s) 138 may therefore be dynamic, or the geographical-based fence(s) 136 and/or the time-based fence(s) 138 utilized to trigger the action(s) may vary.

Although FIG. 1 illustrates and describes the store 106 being a grocery store and the customer 102 ordering groceries, the techniques herein extend to other forms of stores and/or pick ups. For example, the techniques discussed herein may be utilized in preparing prescriptions at pharmacies, preparing takeout meals at restaurants, preparing/readying dry-cleaning, preparing other orders at retail stores or item pick up locations, and so forth. Moreover, in addition or alternative to using the store associate(s) 132 for preparing and/or delivering the order 104, robotic drives or devices may prepare and/or deliver the orders to the customers at the designated pick up locations. In order to navigate with the store 106 and/or to the designated pick up locations, the robotic drives may include sensors and/or cameras and utilize a layout of the store 106.

Additionally, in some instances, the customer who purchased the order 104 may not pick up the order, but instead, may instruct an alternative person (e.g., an assistant, friend, family member, nanny, housekeeper, etc.) to pick up the order 104 at the store 106. In such instances, the customer 102 may share an indication of the order 104 with the alternative person. Additionally, or alternatively, the customer 102 who purchased the order 104 may indicate the alternative person to pick up the order 104, and the ordering service 110 may transmit an indication to the alternative person of the order 104. The alternative person may confirm that they are picking up the order 104, and in doing so, the ordering service 110 may track the device of the alternative person to determine the ETA 140 and/or the TOT 142. In some instances, the alternative person may first opt-in or agree to having their location tracked for use by the ordering service 110 in determining the ETA 140 and the TOT 142.

As used herein, a processor, such as the processor(s) 120, or the processor(s) of the customer device 108 and/or the store associate device 114, may include multiple processors and/or a processor having multiple cores. Further, the processor(s) may comprise one or more cores of different types. For example, the processor(s) may include application processor units, graphic processing units, and so forth. In one implementation, the processor(s) may comprise a microcontroller and/or a microprocessor. The processor(s) may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program components, program data, and/or one or more operating systems.

The memory 122, or the processor(s) of the customer device 108 and/or the store associate device 114 may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

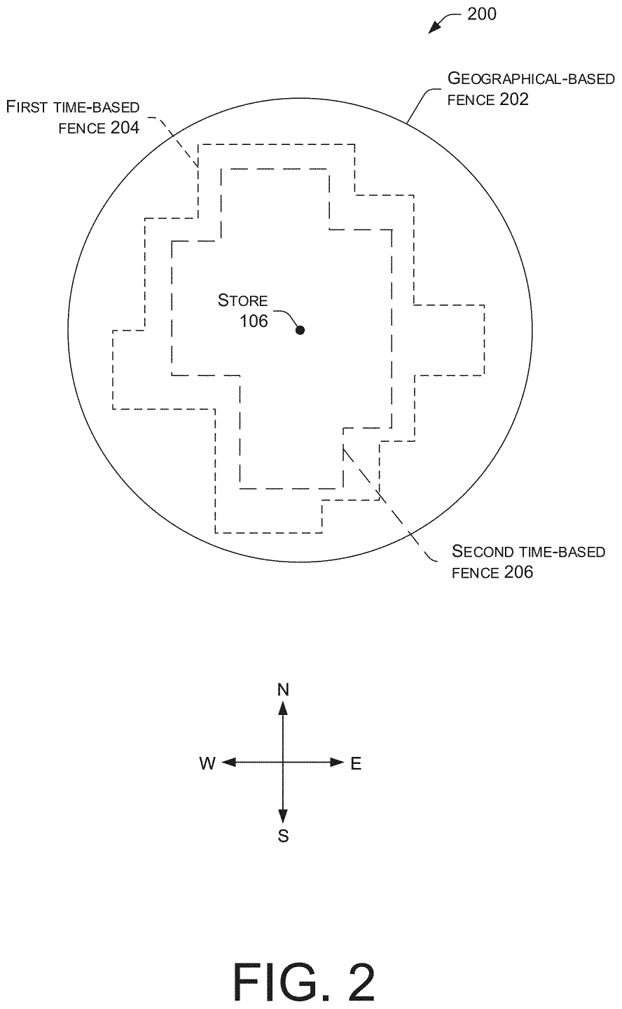

FIG. 2 illustrates an example environment 200 illustrating one or more geographical-based fences (e.g., the geographical-based fence(s) 136) and one or more time-based fences (e.g., the time-based fence(s) 138). As discussed above, the geographical-based fence(s) 136 and the time-based fence(s) 138 may be utilized when performing action(s) (e.g., the action(s) 134) associated with the customer 102 picking up the order 104 at the store 106.

As shown, the environment 200 may include a geographical-based fence 202 around the store 106. In some instances, the geographical-based fence 202 may encircle the store 106 by a certain radius or distance. For example, the geographical-based fence 202 may include a radius of five miles that encircles the store 106. In some instances, the geographical-based fence 202 may not be centered at the store 106 so long as the perimeter of the geographical-based fence 202 encircles the perimeter of the time-based fence.

As discussed above, upon the customer 102 entering the geographical-based fence 202, a distance from the customer 102 to the store 106 may be known or determined. That is, when the notification is received upon the customer device 108 entering the geographical-based fence 202, the distance between the customer 102 and the store 106 is known (e.g., from the radius or size of the geographical-based fence 202). However, in some instances, the distance may not indicate how long it may take for the customer 102 to reach the store 106. For example, entering within the geographical-based fence 202 may not indicate whether the customer 102 is heading to the store 106 from the north, south, east, or west. Such characteristics, however, may impact the ETA 140 and/or the TOT 142 of the customer 102 (e.g., traffic, road networks, time of day, etc.). Accordingly, in some instances, the time-based fences may be utilized to track or determine the location of the customer 102 within the geographical-based fence 202. In some instances, the customer 102 may be tracked within the geographical-based fence 202 to better approximate the ETA 140 and/or the TOT 142. This increased accuracy may eliminate and/or reduce wait times of the customer 102 and/or the store associate(s) 132.

For example, the environment 200 may include a first time-based fence 204 and/or a second time-based fence 206. The first time-based fence 204 and the second time-based fence 206 may represent, or be associated with, a respective TOT to the store 106. For example, the first time-based fence 204 may be set at ten minutes from the store 106 and the second time-based fence 206 may be set at five minutes from the store 106. At points or positions along the first time-based fence 204, the customer 102 may be estimated to be ten minutes from the store 106. At points outside the first time-based fence 204, the customer 102 may be more than ten minutes from the store 106, while at points within the first time-based fence 204 the customer 102 may be less than ten minutes from the store 106. At points or positions along the second time-based fence 206, the customer 102 may be estimated to be five minutes from the store 106. At points outside the second time-based fence 206, the customer 102 may be more than five minutes from the store 106, while at points within the second time-based fence 206 the customer 102 may be less than five minutes from the store 106. In some instances, all of or portions of the first time-based fence 204 and the second time-based fence 206 may follow a road network around the store 106. For example, based on infrastructure around the store 106, points along respective roadways, alleyways, sidewalks, or other paths may be plotted. These points may represent a TOT to the store 106 and collectively, the points may be joined to form the time-based fence(s).

As the customer 102 crosses the first time-based fence 204 and the second time-based fence 206, different actions (e.g., the action(s) 134) may be performed. For example, by tracking the customer 102, as the customer 102 enters within the first time-based fence 204 and the second time-based fence 206, respectively, indications may be provided to the store associates 112 for performing the action(s) 134. That is, knowing the travel time allows store associate 112 to better plan and manage the order 104. By way of example, when the customer 102 crosses the first time-based fence 204, the order 104 of the customer 102 may be prepared. When the customer 102 crosses the second time-based fence 206, the store associate 112 may transport the order 104 to the designated pick up locations. The first time-based fence 204 and the second time-based fence 206 may therefore be utilized when the customer 102 is within the geographical-based fence 202 and once inside the geographical-based fence 202, a real-time tracking session may be implemented to determining the ETA 140 and/or the TOT 142. The real-time tracking session may continuously receive the tracking information (e.g., the tracking information 144) of the customer 102 for use in determining the ETA 140 and/or the TOT 142. In some instances, the customer device 108 may transmit the tracking information 144 on a continuous basis or pre-scheduled basis, such as every ten seconds. Moreover, tracking the customer 102 within the geographical-based fence 202, as compared to outside the geographical-based fence 202, may conserve battery power of the customer device 108. As such, depending on the location of the customer 102 within the geographical-based fence 202, his or her direction of travel, the traffic, etc., the ETA 140 and/or the TOT 142 may be continuously determined. Upon crossing the first time-based fence 204 and the second time-based fence 206, or other time-based fences, the action(s) 134 may be triggered. For example, by way of another example, crossing the first time-based fence 204 may instruct the store associate 12 to prepare or gather non-perishable item(s) within the order 104, and crossing the second time-based fence 206 may instruct the store associate 112 to prepare or gather perishable item(s) within the order 104.

Furthermore, although the environment 200 illustrates a particular arrangement or shape of the first time-based fence 204 and the second time-based fence 206, other shapes or outlines are envisioned. For example, the first time-based fence 204 and the second time-based fence 206 may be closer to the store 106 in north, south, east, or west directions. Noted above, the first time-based fence 204 and the second time-based fence 206 may follow or be arranged based on a road network and/or a pedestrian network around the store 106. In some instances, the first time-based fence 204 and the second time-based fence 206 may or may not be continuous around the store 106 and/or completely surround the store 106. For example, the store 106 may not be accessible from certain directions. Additionally, more than two time-based fences (e.g., the first time-based fence 204 and the second time-based fence 206) may be established around the store 106. For example, a third time-based fence may be established around the store 106, that when crossed, causes another of the action(s) 134 to be performed. The first time-based fence 204 and the second time-based fence 206 may also dynamically change based on a current time of day. For example, in early morning or late evening hours when traffic is reduced, a time-based fence associated with one minute from the store 106 may be farther away from the store 106 as compared to hours during rush hour.

Furthermore, in some instances, a size of the geographical-based fence 202 may be determined or set based on a size or area of the first time-based fence 204 and/or the second time-based fence 206. That is, as the first time-based fence 204 and/or the second time-based fence 206 are determined (e.g., when the store 106 and/or the store associate(s) 132 are instructed to perform the action(s) 132), the geographical-based fence 202 may be determined. By way of example, if the ordering service 110 determines that action(s) 134 are to be performed when the customer 102 is ten minutes away (e.g., assemble item(s) of the order 104) from the store 106 and 30 seconds away from the store 106 (e.g., deliver the item(s) to the customer 102), the geographical-based fence 202 may be established. The geographical-based fence 202 may be established at a certain offset from point(s) of the time-based fence(s), such as 100 feet from a furthest point on the outermost time-based fence. A size of the geographical-based fence 202 may also be based at least in part on a time of day associated with the order 104, a number of item(s) of the order 104, the specific item(s) of the order, and/or a number of order(s) 104 currently being fulfilled at the store 106.

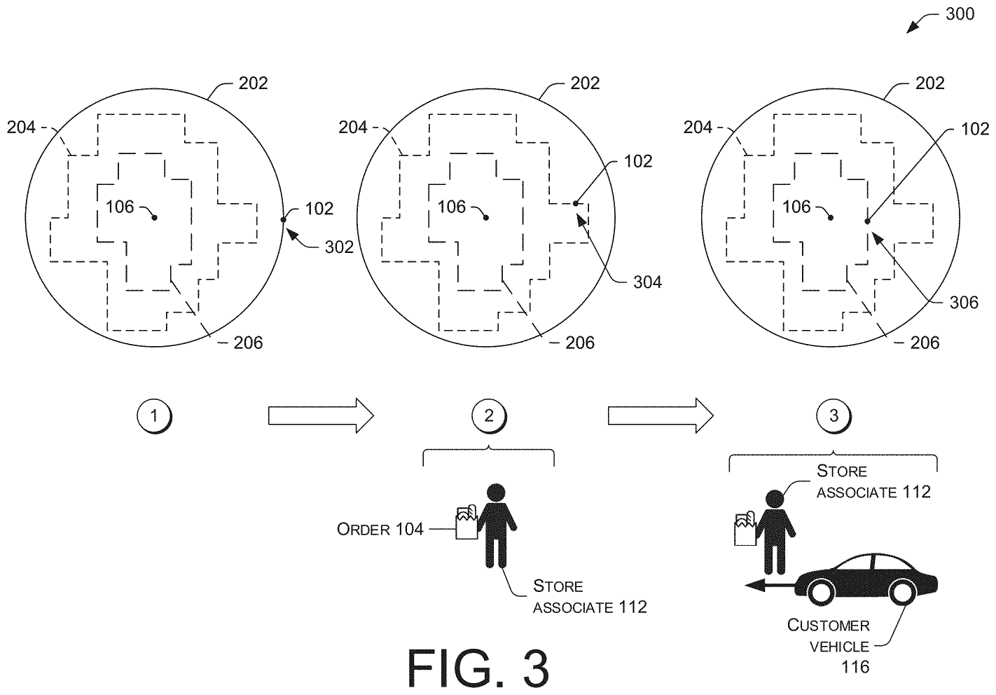

FIG. 3 illustrates an example flow of operations 300 for determining the ETA 140 and/or the TOT 142 for performing one or more of the action(s) 134. FIG. 3 illustrates the geographical-based fence 202 surrounding the store 106. FIG. 3 also illustrates the first time-based fence 204 and the second time-based fence 206.

At “1” the customer 102 may be at a first location 302 and enter or breach the geographical-based fence 202. For example, the customer 102, after placing the order 104, may travel to the store 106 to pick up the order 104. Upon traveling to the store 106, the customer 102 crosses the geographical-based fence 202 and comes within a certain distance of the store 106 (e.g., five miles). In some instances, upon entering the geographical-based fence 202 or upon crossing the geographical-based fence 202, the customer 102 may be tracked (e.g., tracking information 144). Additionally, or alternatively, the ETA 140 and/or the TOT 142 of the customer 102 to the store 106 may be determined using traffic information, a network of roads, etc.

At “2” the customer 102 may be at a second location 304 at or along the first time-based fence 204. The first time-based fence 204, for example, may be established five minutes from the store 106 (e.g., at the first time-based fence 204, it may take the customer 102 five minutes to travel to the store 106). Along the first time-based fence 204, the customer 102 may be considered five minutes away from the store 106. In some instances, the first time-based fence 204 may include varying shapes and/or outlines based on a configuration of the streets around the store 106. For example, depending on the direction the customer 102 approaches the store 106, the traffic in each direction, and/or the road network around the store 106, the amount of time to travel to the store 106 may vary. As such, the first time-based fence 204 may take varying shapes depending on the location relative to the store 106. In response to determining that the customer 102 is within the first time-based fence 204 (e.g., within a first certain time threshold of the store 106), one or more of the action(s) 134 may be performed. For example, the store associate 112 may prepare the order 104 of the customer 102 in anticipation of the customer 102 arriving at the store 106 in five minutes.

At “3” the customer 102 may be at a third location 306 along the second time-based fence 206. The second time-based fence 206, for example, may be established one minute from the store 106 (e.g., at the second time-based fence 206, it may take the customer 102 one minute to travel to the store 106). Along the second time-based fence 206, the customer 102 may be considered one minute away from the store 106. In some instances, the second time-based fence 206 may include varying shapes and/or outlines based on a configuration of the streets around the store 106. For example, depending on the direction the customer 102 approaches the store 106, the traffic in each direction, and/or the road network around the store 106, the amount of time to travel to the store 106 may vary. As such, the second time-based fence 206 may take varying shapes depending on the location relative to the store 106. In response to determining that the customer 102 is with the second time-based fence 206 (e.g., within a second certain time threshold of the store 106), one or more of the action(s) 134 may be performed. For example, the store associate 112 may gather the order 104 from a holding area (e.g., refrigeration and/or holding area) within the store 106 and/or begin walking the order 104 to designated pick up locations for delivering the order 104 to the customer 102. For example, the customer 102 may be traveling in the customer vehicle 116 and the store associate 112 may deliver the order 104 to the customer 102.

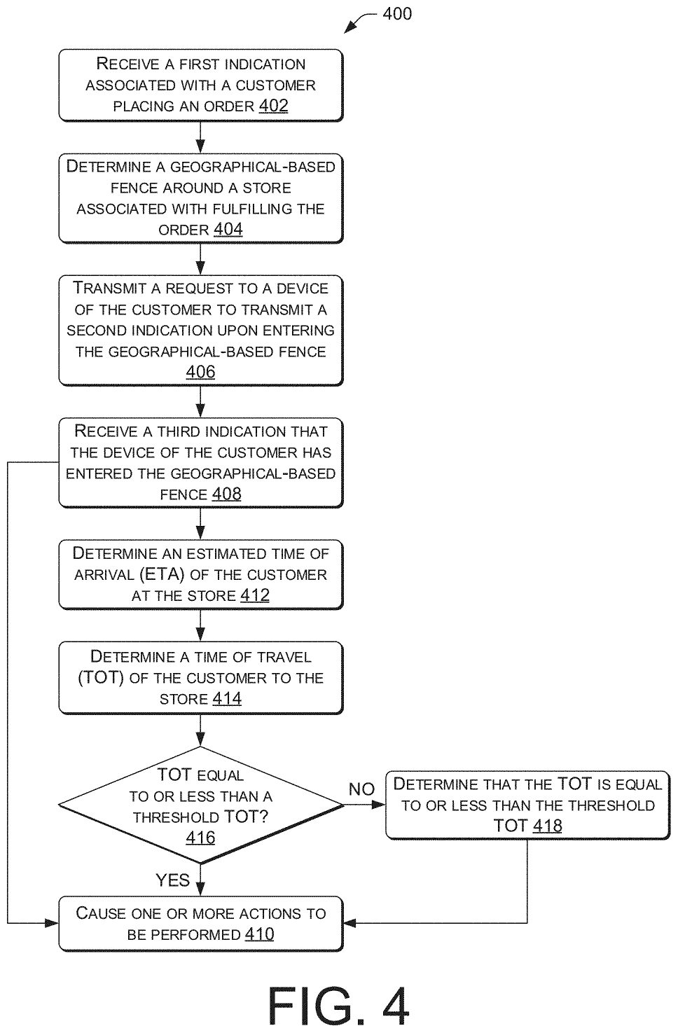

FIGS. 4-7 illustrate various processes related to determining an ETA and a TOT for customers placing online orders, and scheduling pick ups. The processes described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures, and systems described in the examples herein, such as, for example those described with respect to FIGS. 1-3, although the processes may be implemented in a wide variety of other environments, architectures, and systems.

FIG. 4 illustrates an example process 400 for scheduling a pick up for a customer. At 402, the process 400 may receive a first indication associated with a customer placing an order. For example, the ordering service 110 may receive an indication that the customer 102 placed the order 104 with the store 106. In some instances, the indication received at 402 may identify a physical location of the store 106 at which the customer 102 is to pick up the order 104 or one or more item(s) of the order 104.

At 404, the process 400 may determine a geographical-based fence around a store fulfilling the order. For example, the ordering service 110 may determine a geographical-based fence (e.g., geofence) that surrounds the store 106 (or any other physical location at which the customer 102 is to travel and pick up previously ordered item(s)). By way of example, the geographical-based fence may be established around a five-mile radius of the store 106. In some instances, the geographical-based fence may be determined based at least in part on the store 106 (e.g., location, staffing, etc.), the order 104 (or the content(s) within the order 104), the road network around the store 106, a number of order(s) 104 queued or being prepared at the store 106, the time of day, and/or a size or shape of time-based fence(s) around the store 106. As discussed herein, the geographical-based fence may be utilized to trigger one or more actions (or events), such as determining a location, ETA, and/or TOT of the customer 106 to the store 106. In some instances, the ordering service 110 may set the geographical-based fence around the store 106, based at least in part on determining the geographical-based fence. The geographical-based fence may therefore be customized to the store 106 and depending on one or more characteristics. However, in some instances, the geographical-based fence may be of a preconfigured size or shape. Additionally, in some instances, more than one geographical-based fence may be established around the store 106.

At 406, the process 400 may transmit a request to a device of the customer to transmit a second indication upon entering the geographical-based fence. For example, the ordering service 110 may transmit the request to the customer device 108 of the customer 102, and instruct the customer device 108 to notify the ordering service 110 upon entering the geographical-based fence. In some instances, based on the customer device 108 receiving the request, the geographical-based fence 106 may be placed, or set, on the customer device 108.

At 408, the process 400 may receive a third indication that the device of the customer has entered the geographical-based fence. For example, the ordering service 110 may receive an indication that the customer device 108 has entered, or is within, the geographical-based fence. The indication may serve to notify the ordering service 110, and subsequently the store 106 and/or store associate(s) 132, that the customer 102 is within a predetermined distance (e.g., five miles) of the store 106.

From 408, the process 400 may proceed to 410, whereby the process 400 may cause one or more actions to be performed. For example, based on the ordering service 110 receiving the notification that the customer 102 is within the geographical-based fence, the ordering service 110 may instruct store associate(s) 132 (e.g., the store associate 112) to perform one or more of the action(s) 134, such as prepare the order 104 (e.g., locate item(s) of the order 104 within the store 106), locate the order 104 (in instances where the order 104 has previously been prepared), and so forth. In other words, and in some instances, based on the customer 102 being a certain or threshold distance from the store 106, the one or more action(s) 134 may be performed to ensure that the order 104 of the customer 102 is being prepared and readied for pick up by the time the customer 102 arrives at the store 106. Moreover, as discussed above, the size of the geographical-based fence or a distance from the store 106 when the ordering service 110 is notified, may be dynamically determined based on one or more characteristics. For example, in instances where the order 104 contains a plurality of items that may take additional time to locate and pack, the geographical-based fence may be set to a larger distance from the store 106, as compared to instances where the order 104 contains only a few items. This may allow the store associate(s) 132 additional time to prepare the order 104. Additionally, at certain times of the day, the store 106 may be busy and the store associate(s) 132 may be given additional time to prepare the order 104. Accordingly, the geographical-based fence may be adjusted to accommodate for the actions that are triggered when the customer 102 enters the geographical-based fence.

At 412, after receiving the indication that the device of the customer is within the geographical-based fence, the process 400 may determine an estimated time of arrival (ETA) of the customer at the store. That is, once the customer 102 is within the geographical-based fence, or based at least in part on determining that the customer 102 is within the geographical-based fence, the process 400 may determine the ETA 140. For example, the ordering service 110 may utilize the size of the geographical-based fence (e.g., the radius) to determine a distance from the customer 102 to the store 106. In some instances, to determine the ETA 140, the ordering service 110 may utilize information about a road network surrounding the store 106, traffic around the store 106, a time of day, GPS coordinates of the customer 102, and so forth, that may impact the ETA 140 of the customer 102. The process 400 may also receive tracking information (e.g., the tracking information 144) to determine the ETA 140. In some instances, the ordering service 110 may utilize various components and/or third-party platforms and/or services for determining the ETA 140. Determining the ETA 140 may provide a better indication of when the customer 102 will, or is expected to, arrive at the store 106 to minimize wait times and increase customer satisfaction. In other words, at 412 the process may convert the distance of the customer 102 into the ETA 140 of the customer 102 at the store 106. For example, the ETA 140 of the customer 102 may be 8:00 p.m.

At 414, the process 400 may determine a travel of travel (TOT) of the customer to the store. For example, the ordering service 110, based at least in part on determining and knowing the ETA 140 of the customer 102, may determine the TOT 142 of the customer 102 to the store 106. The TOT 142 may represent an estimated amount of time for the customer 102 to travel to the store 106 upon entering the geographical-based fence. For example, if the ETA 140 is 8:00 p.m. and the current time is 7:50 p.m., the ordering service 110 may determine that the TOT 142 is ten minutes. In other words, the ordering service 110 may determine that the customer 102 is estimated to arrive at the store 106 in ten minutes.

At 416, the process 400 may determine whether the TOT is equal to or less than a threshold TOT. For example, the ordering service 110 may compare the TOT 142 (as determined at 414) with a threshold TOT for determining whether the TOT 142 is equal to, less than, or greater than the threshold TOT. In some instances, the threshold TOT may be determined based at least in part on the store 106 (e.g., location, staffing, etc.), the order 104 (or the content(s) within the order 104), the road network around the store 106, and/or the time of day. As discussed herein, the threshold TOT may be set, or utilized, to trigger or cause one or more actions. For example, if the TOT 142 is ten minutes, but the store associate(s) 132 only need one minute to deliver the order 104 to the customer 102, then the TOT 142 may be greater than the threshold TOT and the one or more action(s) 134 may not be triggered. In this sense, the store associate(s) 132 may only need to be notified when the customer 102 is within one minute of the store 106 to allow enough time for the store associate(s) 132 to deliver the order 104 to designated pick up locations. In such instances, each of the action(s) 134 may be associated with a respective threshold TOT.

Accordingly, at 416, if the process 400 determines that the TOT is equal to or less than the threshold TOT, the process 400 may follow the “YES” route and proceed to 410. At 410, the process 400 may cause one or more actions to be performed. For example, noted above, the store associate(s) 132 may be instructed to locate the order 104 (e.g., within a holding area at the store 106) and deliver the order 104 to the customer 102 at the designated pick up location(s). Here, the ordering service 110 may transmit a notification or instruction to the store associate device 114 to deliver the order 104 to the customer 102. Accordingly, instructing the store associate(s) 132 to perform the action(s) 134 when the customer 102 is within the threshold TOT may reduce wait times of the customer 102 and/or the store associate(s) 132.

Alternatively, if at 416 the process 400 determines that the TOT is greater than the threshold TOT, the process 400 may follow the “NO” route and proceed to 418. At 418, the process 400 may determine that the TOT is equal to or less than the threshold TOT. For example, in instances where the process 400 determines that the TOT is not equal to or less than the threshold TOT, at 416, the process 400 may begin a counter or countdown, and at the 418, may determine that the TOT is equal to or less than the threshold TOT. From 418, the process 400 may proceed to 410 to cause the one or more action(s) to be performed. For example, based at least in part on determining that the TOT is equal to or less than the threshold TOT at 418, the ordering service 110 may instruct the store associate(s) 132 to deliver the order 104 to the customer 102 at the designated pick up locations.

Accordingly, FIG. 4 and the process 400 may illustrate and describe a scenario whereby the ordering service 110 may utilize the geographical-based fence, or an indication that the customer 102 enters within the geographical-based fence, to determine the ETA 140 and the TOT 142 of the customer 102. In such instances, the ETA 140 and/or the TOT 142 may be utilized to determine when to perform actions, such as preparing the order 104 and/or delivering order 104 to the customer 102 at designated pick up locations. The process 400 may, in some instances, represent a scenario where the ETA 140 and/or the TOT 142 are determined at a single instance and are not updated while the customer 102 is within the geographical-based fence (e.g., receiving additional tracking information 144). As part of this, the process 400 may transmit instructions to the store associate(s) 132 to perform the action(s) 134. Additionally, in some instances, the process 400 may provide instructions to the customer 102, via the customer device 108, associated with the pick up locations and/or to instruct the customer 102 as to where he/she may pick up the order 104. For example, the ordering service 110 may transmit an indication that the order 104 will be ready in a certain amount of time and/or at a certain time, or that the order 104 is ready or pick up. In some instances, the customer 102 may indicate when they are on their way to pick up the order 104, which may cause the ordering service 110 to be on the lookout for the customer device 108.

Although the process 400 discusses determining the TOT 142 and comparing the TOT to a threshold TOT, the ETA 140 in some instances may be compared against a threshold ETA for use in performing the action(s) 134. Furthermore, the process 400 and the ordering service 110 may determine the ETA 140 and the TOT 142 for a plurality of the customers 102 in parallel. Each of the customers 102 may place the order(s) 104, respectively, or each of the customers 102 may have an order, among the order(s) 104 to be picked up. For example, for a first customer that placed a first order at a first store, the ordering service 110 may determine a first ETA and a first TOT. Based on the first ETA and/or the first TOT, the ordering service 110 may instruct a first store associate at the first store to perform one or more first actions. Additionally, for a second customer that placed a second order at a second store, the ordering service 110 may determine a second ETA and a second TOT. Based on the second ETA and/or the second TOT, the ordering service 110 may instruct a second store associate at the second store to perform one or more second actions. However, in some instances, the ordering service 110 may additionally or alternatively manage multiple orders, and store associates, at a single store. As such, the ordering service 110 may be configured to coordinate the pick up of a plurality of orders for different customers and across a plurality of stores.

Additionally, the process 400 may compare the ETA and/or the TOT to multiple thresholds, respectively, for use in performing one or more action(s). For example, although the process 400 illustrates the comparison of TOT to a threshold TOT, the process 400 may, in some instances, compare a calculated ETA and/or a calculated TOT to one or more thresholds, respectively, for causing one or more action(s) to be performed.

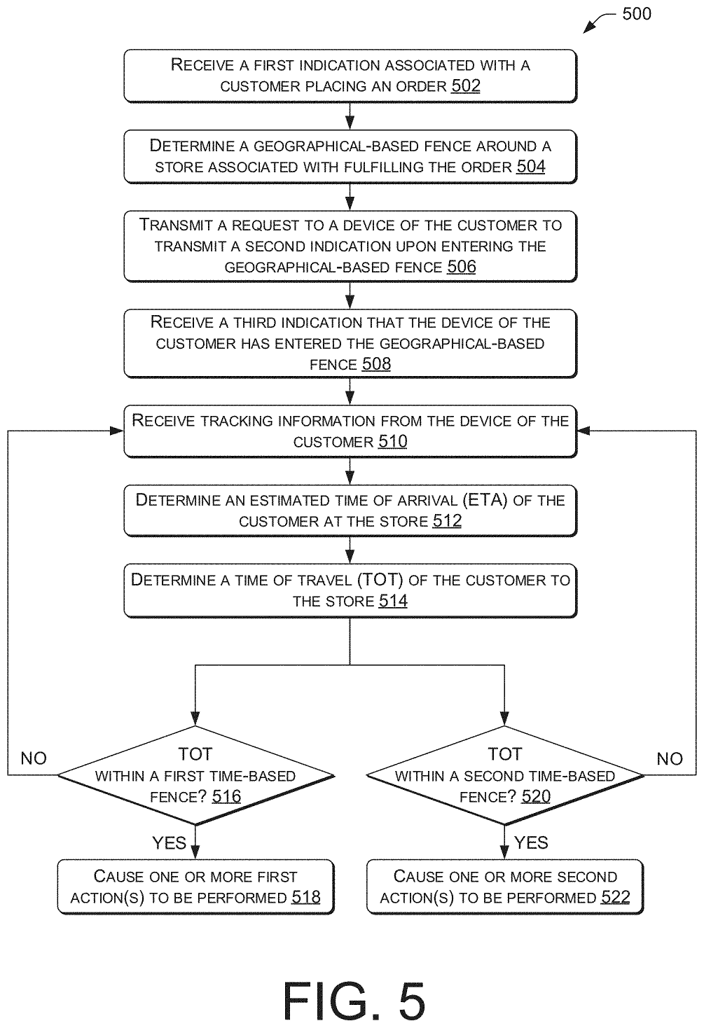

FIG. 5 illustrates an example process 500 for scheduling a pick up for a customer. At 502, the process 500 may receive a first indication associated with a customer placing an order. For example, the ordering service 110 may receive an indication that the customer 102 placed the order 104 with the store 106. In some instances, the indication received at 502 may identify a physical location of the store 106 at which the customer 102 is to pick up the order 104 or one or more item(s) of the order 104.

At 504, the process 500 may determine a geographical-based fence around a store fulfilling the order 104. For example, the ordering service 110 may determine a geographical-based fence (e.g., geofence) that surrounds the store 106. By way of example, the geographical-based fence may be established around a five-mile radius of the store 106. The geographical-based fence may be determined based at least in part on the store 106 (e.g., location, staffing, etc.), the order 104, the road network around the store 106, a number of order(s) 104 queued or being prepared at the store 106, the time of day, and/or one or more time-based fence(s) established around the store 106. In some instances, the ordering service 110 may set the geographical-based fence around the store 106, based at least in part on determining the geographical-based fence. However, in some instances, the geographical-based fence may be of a preconfigured size or shape. Discussed herein, the geographical-based fence may be utilized to trigger one or more actions (or events) and as such, the geographical-based fence may be customized to the store 106 and depending on one or more characteristics. In some instances, more than one geographical-based fence may be established around the store 106.

At 506, the process 500 may transmit a request to a device of the customer to transmit a second indication upon entering the geographical-based fence. For example, the ordering service 110 may transmit the request to the customer device 108 of the customer 102, and instruct the customer device 108 to notify the ordering service 110 upon entering the geographical-based fence. In some instances, based on the customer device 108 receiving the request, the geographical-based fence may be placed, or set, on the customer device 108.

At 508, the process 500 may receive a third indication that the device of the customer has entered the geographical-based fence. For example, the ordering service 110 may receive an indication that the customer device 108 has entered, or is within, the geographical-based fence. The indication may serve to notify the ordering service 110, and subsequently the store 106 and/or store associate(s) 132, that the customer 102 is within a predetermined distance of the store 106 (e.g., within the geographical-based fence).

At 510, the process 500 may receive tracking information from the device of the customer. For example, the ordering service 110 may receive the tracking information 144 from the customer device 108, and based at least in part on the customer device 108 being within the geographical-based fence. In some instances, the ordering service 110 may automatically receive the tracking information 144 from the customer device 108 and based at least in part on the customer device 108 transmitting the indication that the customer device 108 has entered the geographical-based fence. That is, once the customer device 108 enters the geographical-based fence, the customer device 108 may be configured to transmit the tracking information 144. Accordingly, the ordering service 110 may receive automatically, without prompting the customer device 108, the tracking information 144. The tracking information 144 may, in some instances, include or represent coordinates of the customer device 108 (e.g., longitude and latitude), a direction of travel of the customer device 108, an acceleration of the customer device 108, a speed of the customer device 108, and so forth. Additionally, or alternatively, however, in some instances, the ordering service 110 may request the tracking information 144 from the customer device 108.

At 512, after receiving the tracking information, the process 500 may determine an estimated time of arrival (ETA) of the customer at the store. In some instances, to determine the ETA 140, the ordering service 110 may utilize the tracking information 144 and/or information about a road network surrounding the store 106, traffic around the store 106, a time of day, and so forth. In some instances, the ordering service 110 may utilize various components and/or third-party platforms and/or services for determining the ETA 140. In the latter, the ordering service 110 may receive an indication of the ETA 140 from the third-party services.

At 514, the process 500 may determine a travel of travel (TOT) of the customer to the store. For example, the ordering service 110, based at least in part on determining and knowing the ETA 140 of the customer 102, may determine the TOT 142. The TOT 142 may represent an estimated amount of time for the customer 102 to travel to the store 106 from a current location of the customer 102. For example, if the ETA 140 is 6:00 p.m. and the current time is 5:45 p.m., the ordering service 110 may determine the TOT142 is fifteen minutes. In other words, the ordering service 110 may determine that the customer 102 is set to arrive at the store 106 in fifteen minutes. In some instances, the third-party services may also be utilized to determine the TOT 142.

From 514, the process 500 may proceed to 516 whereby the process 500 may determine whether the TOT is within a first time-based fence. For example, the ordering service 110 may compare the TOT 142 with a first time-based fence to determine whether the customer 102 is within a certain time threshold of the store 106. The first time-based fence may represent, from various points around the store 106, an estimated TOT and indicate that the customer 102 is within a first time threshold of the store 106. This first time-based fence may surround the store 106 in multiple directions and/or follow a road network around the store 106. In some instances, the first time-based fence may not be continuous or completely surround the store 106, and may follow the road and/or pedestrian network around the store 106. The first time-based fence may be determined, or set, by joining points along the road network that are a TOT away from the store 106 associated with the first time-based fence. That is, the first time-based fence may be established using points along the various road networks around the store 106, and which correspond to a TOT associated with the first time-based fence. As the customer 102 enters the first time-based fence, or is within the first time-based fence, this may signify that the customer 102 is within a certain time of the store 106, which, as discussed herein, may be utilized to trigger one or more action(s) 134. For example, the first time-based fence may be set at five minutes from the store 106, and at the first time-based fence, the customer 102 may be five minutes from the store 106. As the customer 102 crosses the first time-based fence, the ordering service 110 may determine that the customer 102 is five minutes from the store 106.

As shown at 518, the process 500 may compare the TOT to determine whether the TOT is within the first time-based fence. For example, if the TOT 142 is ten minutes and the first time-based fence is set at five minutes, the process 500 may determine that the customer 102 is not within the first time-based fence. At 518, if the process 500 determines that the TOT 142 is not within the first time-based fence, the process 500 may follow the “NO” route and loop to 510. Here, the process 500 may continuously receive the tracking information 144 for continuously updating the ETA 140, the TOT 142, and/or comparing the TOT 142 to the first time-based fence. In some instances, the customer device 108 may transmit the tracking information 144 on a continuous or pre-scheduled basis, such as every ten seconds. As such, the process 500 may continuously determine the ETA 140 and the TOT 142 of the customer 102.

Once the process 500 determines that the TOT is within the first time-based fence, or that the TOT is within a first time threshold corresponding to the first time-based fence (e.g., five minutes), the process may follow the “YES” route and proceed to 518. At 518, the process 500 may cause one or more first action(s) to be performed. For example, the ordering service 110 may instruct store associate(s) 132 (e.g., the store associate 112) to prepare the order 104 (e.g., locate item(s) of the order 104 within the store 106), locate the order 104 (in instances where the order 104 has previously been prepared), and so forth. In other words, based on the customer 102 entering the first time-based fence, one or more first action(s) may be performed to ensure that the order 104 of the customer 102 is being prepared and readied for pick up when the customer 102 arrives at the store 106.

Additionally, or alternatively, in some instances, from 514, the process 500 may proceed to 520 whereby the process 500 may determine whether the TOT is within a second time-based fence. For example, the ordering service 110 may compare the TOT with a second time-based fence to determine whether the customer 102 is within a certain time of the store 106. The second time-based fence may represent an estimated time of travel and indicate that the customer 102 is within a second time threshold of the store 106. This second time-based fence may surround the store 106 in multiple directions and/or follow a road network around the store 106. In some instances, the second time-based fence may not be continuous or completely surround the store 106, and may follow the road and/or pedestrian network around the store 106. The second time-based fence may be determined, or set, by joining points along the road network that are a TOT away from the store 106 associated with the second time-based fence. That is, the second time-based fence may be established using points along the various road networks around the store 106, and which correspond to a TOT associated with the second time-based fence. As the customer 102 enters the second time-based fence, or is within the second time-based fence, this may signify that the customer 102 is within a certain time from the store 106, which, as discussed herein, may be utilized to trigger one or more action(s) 134. For example, the second time-based fence may be set at one minute from the store 106 and along points of the second time-based fence, the customer 102 may be one minute from the store 106. As the customer 102 crosses the second time-based fence, the ordering service 110 may determine that the customer 102 is one minute from the store 106.

As shown at 520, the process 500 may compare the TOT to determine whether the TOT is within the second time-based fence. For example, if the TOT is five minutes and the second time-based fence is set at one minute, the process 500 may determine that the customer 102 is not within the second time-based fence. However, as discussed above, the process 500 may also determine whether the TOT 142 is within the first time-based fence for causing one or more first action(s) to be performed. At 520, if the process 500 determines that the TOT is not within the second time-based fence, the process 500 may follow the “NO” route and loop to 510. Here, the process 500 may continuously receive the tracking information 144 for continuously updating the ETA 140, the TOT 142, and/or comparing the TOT 142 to the second time-based fence. In some instances, the customer device 108 may transmit the tracking information 144 on a continuous basis or pre-scheduled basis, such as every ten seconds. As such, the process 500 may continuously determine the ETA 140 and the TOT 142 of the customer 102.

Once the process 500 determines that the TOT is within the second time-based fence, or that the TOT is within a second time threshold corresponding to the second time-based fence (e.g., one minute), the process may follow the “YES” route and proceed to 522. At 522, the process 500 may cause one or more second action(s) to be performed. For example, the ordering service 110 may instruct store associate(s) 132 (e.g., the store associate 112) to locate the order 104 (e.g., within a holding area at the store 106) and deliver the order 104 to the customer 102 at the designated pick up location(s). Here, the ordering service 110 may transmit a notification or instruction to the store associate device 114 to deliver the order 104 to the customer 102.

Accordingly, FIG. 5 and the process 500 illustrate a scenario whereby the ordering service 110 may utilize the geographical-based fence(s) 136 and/or the time-based fence(s) 138 for determining the ETA 140 and/or the TOT 142 of the customer 102 for causing the action(s) 134 to be performed. The time-based fence(s) 138 may be utilized when the customers 102 are within the geographical-based fence(s) 136 and once inside the geographical-based fence(s) 136, a real-time tracking session may be implemented. Herein, the real-time tracking session may continuously receive the tracking information 144 of customers 102 for use in determining the ETA 140 and the TOT 142 of each of the customers 102. In some instances, the customer devices may transmit the tracking information 144 on a continuous basis or pre-scheduled basis for by the ordering service 110 (or third-party platforms and/or services) to determine when the customers 1020 will arrive. As such, the process 500 may track the customer devices to periodically determine the ETA 140 and/or the TOT 142 from the location as tracked to instruct the store associate(s) 132 to begin collecting item(s) within the order(s) 104 for the customers 102, respectively, for delivering the item(s) of the order(s) 104 to their corresponding pick up locations at the stores. That is, although FIG. 5 and the process 500 illustrates and discusses determining the ETA 140 and the TOT 142 for a single customer at a particular store and performing one or more actions, the process 500 and the ordering service 110 may determine an ETA 140 and a TOT 142 for a plurality of customers in parallel. For example, for a first customer that placed a first order at a first store, the ordering service 110 may continuously determine the TOT 142 for comparison with the time-based fence(s) 138 and performing the action(s) 134. Additionally, for a second customer that placed a second order at a second store, the ordering service 110 may continuously determine the TOT 142 for comparison with the time-based fence(s) 138 and performing the action(s) 134. In some instances, the ordering service 110 may additionally or alternatively manage multiple orders, and store associates, at a single store. As such, the ordering service 110 may coordinate the pick up of a plurality of the order(s) 104 for different customers 102 and across a plurality of stores. Additionally, although the process 500 discusses determining the TOT 142 and comparing the TOT 142 to the time-based fence(s) 138, the ETA 140 in some instances may be compared against the time-based fence(s) 138 for use in performing the action(s) 134.

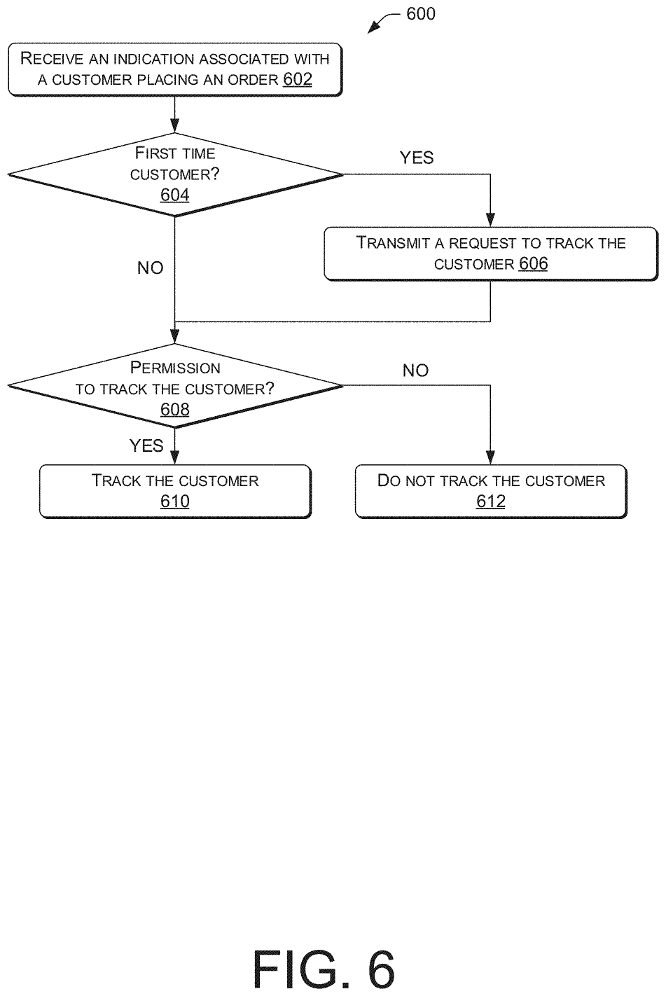

FIG. 6 illustrates an example process 600 for determining whether to monitor a customer when scheduling a pick up, or when a customer is picking up at order. At 602, the process 600 may receive an indication associated with a customer placing an order. For example, the ordering service 110 may receive an indication that the customer 102 placed the order 104 at the store 106.

At 604, the process 600 may determine whether the customer is a first time customer. For example, upon receiving the indication associated with the customer 102 placing the order 104, the ordering service 110 may determine whether the customer 102 is a repeated customer, or whether the customer 102 is a first time customer that has not previously utilized the ordering service 110 for scheduling pick ups. In some instances, the ordering service 110 may utilize an identifier of the customer 102 (e.g., name, username, email address, device identifier, etc.) to determine whether the customer 102 is a repeated customer or a first time customer, or other information stored in the customer data 124.

At 604, if the process 600 determines that the customer 102 is a first time customer, the process may follow the “YES” route and proceed to 606. At 606, the process 600 may transmit a request to track the customer. For example, the ordering service 110 may transmit a request to the customer device 108, requesting that the customer 102 permit the ordering service 110 to track the customer 102. In some instances, the request may request that the customer 102 allow the ordering service 110 to track the customer 102 within a geographical based-fence of the store 106. In some instances, the request may request that the customer 102 allow the customer device 108 to transmit the tracking information 144 to the ordering service 110.

From 606, the process 600 may continue to 608 whereby the process 600 may determine whether the customer has agreed to tracking. For example, the ordering service 110 may determine whether the customer 102 has permitted the ordering service 110 to track the customer 102. In some instances, the ordering service 110 may receive an indication or approval from the customer 102.

Returning to 604, if the process 600 determines that the customer 102 is not a first time customer, the process 600 may proceed to 608. For example, the ordering service 110 may determine that the customer 102 is not a first time customer and that the customer 102 has previously utilized the ordering service 110.

If at 608 the process 600 determines that the ordering service 110 has received permission to track the customer 102, or has permission to track the customer 102, the process 600 may follow the “YES” route and proceed to 610. For example, the ordering service 110 may determine, based on a profile of the customer 102, that the customer 102 has approved or permitted tracking. In some instances, tracking the customer 102 may involve tracking the customer 102 within the geographical-based fence of the store 106. For example, the ordering service 110 may receive indication(s) associated with the customer 102 entering the geographical-based fence and/or may continuously receive the tracking information 144 from the customer device 108 to track the customer 102 and determine the ETA 140 and/or the TOT 142.

Alternatively, if at 608 the process 600 determines that the customer 102 has not provided the ordering service 110 with permission to track the customer 102, the process 600 may follow the “NO” route and proceed to 612. At 612, the process 600 may determine to not track the customer. For example, the ordering service 110 may have not received permission from the customer 102. In some instances, the profile of the customer 102 (e.g., the customer data 124) may indicate that the customer 102 has previously denied tracking. Additionally, or alternatively, the ordering service 110 may receive a response, based on transmitting the request at 606, indicating that the customer 102 did not approve of the ordering service 110 tracking the customer 102. As such, if the process 600 proceeds to 612, the ordering service 110 may not request and/or receive the tracking information 144 from the customer device 108.

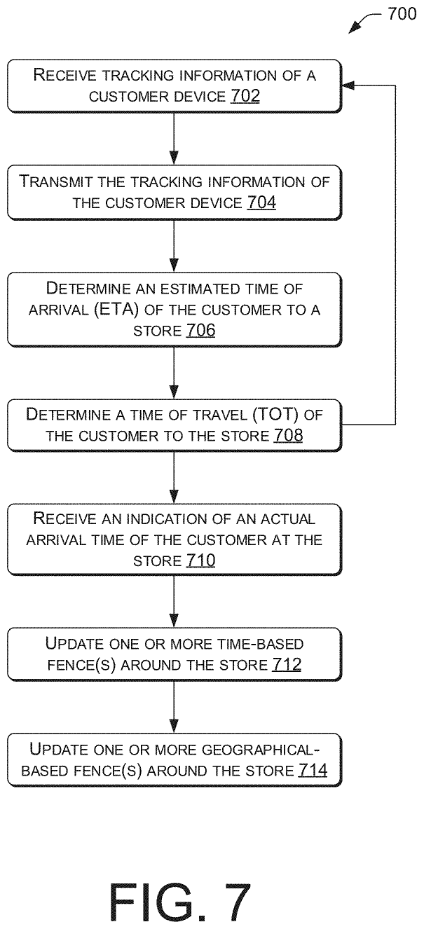

FIG. 7 illustrates an example process 700 for determine an estimated arrival time (ETA) and/or a time of travel (TOT) of the customer to a store, as well as updating one or more time-based fences around the store.

At 702, the process 700 may receive tracking information from a customer device. For example, the ordering service 110 may receive tracking information 144 from the customer device 108 that indicates coordinates (e.g., longitude and latitude), a direction of travel, acceleration, speed, etc. of the customer 102.

At 704, the process 700 may transmit the tracking information. For example, the ordering service 110 may transmit the tracking information 144 of the customer device 108 to one or more third-party services. In some instances, the one or more third-party services may be utilized by the ordering service 110 for determining an estimated time when the customer 102 is scheduled to reach the store 106. In some instances, the third-party services may utilize, or have access to, various sources of information for use in determining when the customer 102 reaches the store 106. For example, the third-party services may utilize traffic information and/or information about a road network around the store 106. In some instances, the third-party services may utilize path prediction components to calculate a predicted path for the customer 102.

At 706, the process 700 may determine an ETA of the customer at the store. For example, the ordering service 110 may receive, from the third-party services, an indication associated with the ETA 140 of the customer 102 at the store 106. In some instances, the ordering service 110 may determine the ETA 140 based on information supplied by the third-party services and/or the ordering service 110 may receive an indication of the ETA 140 from the third-party services.

At 708, the process may determine a TOT of the customer to the store. For example, the ordering service 110 may receive, from the third-party services, an indication associated with the TOT 142 of the customer 102 to the store 106. In some instances, the ordering service 110 may determine the TOT 142 based on information supplied by the third-party services, such as the ETA 140. Additionally, or alternatively, the ordering service 110 may receive an indication of the TOT 142 from the third-party services.

From 708, the process 700 may loop to 702 whereby the process 700 may receive additional tracking information 144 from the customer device 108. Therein, the process 700 may determine the ETA 140 and/or the TOT 142, or an updated ETA and/or updated TOT, for use in accurately determining when the customer 102 will arrive at the store 106.

Additionally, from 708, the process 700 may continue to 710. At 710, the process 700 may receive an indication of an actual arrival time of the customer at the store. For example, the ordering service 110 may receive an indication from the store associate device 114 that the customer 102 arrived at the store 106. However, other techniques may be used to determine a time the customer 102 arrived at the store 106 (e.g., tracking formation, scanners outside store, indication from customer 102, etc.).

At 712, the process 700 may update one or more time-based fence(s) around the store. For example, the ordering service 110, may determine, based at least in part on the actual time of arrival, to update one or more time-based fence(s) 138. As discussed above, the time-based fence(s) 138 may be utilized when triggering one or more action(s) 134, such as preparing the order 104 and/or delivering the order 104 to a pick up location. Accordingly, over time, the time-based fence(s) 142 may be updated based on feedback indicating differences between the ETA 140 and/or the TOT 142. Such feedback may increase an accuracy of accurately predicting the ETA 140 and/or the TOT 142 in future instances to reduce wait times of the customers 102 and/or the store associate(s) 132. In some instances, the ordering service 110 may employ machine-learning techniques to improve the accuracy in calculating the ETA 140 and/or the TOT 142. By way of example, at a first instance, the ordering service 110 may determine a first ETA and/or a first TOT for the customer 102 picking up a first order. Discussed above, the ordering service 110 (and/or one or more third-party service) may track the customer 102 and the actual time of arrival and/or the actual TOT. The actual time of the arrival or the actual TOT, may be used to train the machine-learning techniques for determining a second ETA and/or a second TOT at a second instance for a second order.

At 714, the process 700 may update one or more geographical-based fence(s). For example, based on the one or more updated time-based fence(s) 138, the geographical-based fence(s) 136 may be updated to encompass or surround the time-based fence(s) 138. In this sense, the geographical-based fence(s) 136 may be larger, or bigger, than the time-based fence(s) 138. Updating the geographical-based fence(s) 136 may ensure that the ordering service 110 receives the tracking information 144, or monitors the customer 102, within the time-based fence(s) 136. In some instances, the geographical-based fence(s) 136 may be established at a certain offset from a furthest geographical-based fence 136. Such offsetting may therefore allow the ordering service 110 to receive the tracking information 144 of the customer device 108 to cause the one or more action(s) 136 to be performed upon entering the time-based fence(s) 136.

While various examples and embodiments are described individually herein, the examples and embodiments may be combined, rearranged and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A system comprising:
one or more processors; and
one or more non-transitory computer-readable media storing computer-executable instructions that, when executed by the one or more processors, cause the one or more processors to perform acts comprising:
receiving a first indication that identifies a physical location of a store at which a customer is to pick up one or more items;
identifying a geographical-based fence around the physical location of the store;
transmitting, to a device of the customer, a request for the device to transmit a second indication upon the device being within the geographical-based fence;
receiving, from the device of the customer and while the customer is in transit to the physical location of the store, the second indication that the device of the customer is within the geographical-based fence;
receiving, from the device of the customer, tracking information that specifies global positioning system (GPS) coordinates of the customer within the geographical-based fence and a speed of the customer;
determining, based on the receiving the second indication and the tracking information, an estimated time of arrival (ETA) of the customer at the physical location of the store;
determining, based on the ETA, a time of travel (TOT) of the customer to the physical location of the store;
determining that the TOT is less than a threshold TOT; and
instructing, based on determining that the TOT is less than the threshold TOT and via an associate device, a store associate to perform one or more actions associated with preparing the one or more items for pick up by the customer at the physical location of the store.

2. The system of claim 1, wherein:
the threshold TOT is associated with a time-based fence disposed around the physical location of the store;
the threshold TOT is based at least in part on at least one of:
a time of day associated with the customer picking up the one or more items; or
the one or more items; and
the ETA is further based on at least one of:
the time of day associated with the customer picking up the one or more items;
an amount of traffic around the physical location of the store; or
a road network around the physical location of the store.

3. The system of claim 1, the acts further comprising:
receiving the tracking information at a first time;
receiving, at a second time subsequent to the first time, second tracking information that specifies second GPS coordinates of the customer within the geographical-based fence and a second speed of the customer;
determining, based on the second tracking information, a second ETA of the customer at the physical location of the store;
determining, based on the second ETA, a second TOT of the customer to the physical location of the store; and
causing one or more additional actions to be performed.

4. The system of claim 3, the acts further comprising determining that the second TOT is less than a second threshold TOT, and wherein causing the one or more additional actions to be performed is based on the second TOT being less than the second threshold TOT.

5. A method comprising:
receiving a first indication that identifies a physical location at which a customer is to pick up one or more items;
setting a geographical-based fence around the physical location;
receiving a second indication that a device of the customer has entered the geographical-based fence;
receiving, based at least in part on the device entering the geographical-based fence, tracking information of the device;
determining, based at least in part on the tracking information and an estimated time of arrival (ETA) of the customer at the physical location, a time of travel (TOT) of the customer to the physical location;
determining that the TOT is less than or equal to a threshold TOT to the physical location; and
causing one or more actions to be performed based at least in part on determining that the TOT is less than or equal to the threshold TOT.

6. The method of claim 5, further comprising:
determining that a second TOT of the customer is less than or equal to a second threshold TOT to the store; and
causing an additional action of the one or more action(s) to be performed based at least in part on determining that the second TOT is less than or equal to the second threshold TOT.

7. The method of claim 5, wherein the tracking information comprises at least one of:
coordinates of the device;
an accuracy of the coordinates of the device;
a speed of the device;
an acceleration of the device; or
a bearing of the device.

8. The method of claim 5, further comprising determining that the customer opted-in for tracking the customer within the geographical-based fence, and wherein receiving the tracking information is based at least in part on determining that the customer opted-in.

9. The method of claim 5, wherein the threshold TOT is associated with a time-based fence around the physical location, and at positions within the time-based fence, the TOT of the customer is less than or equal to the threshold TOT.

10. The method of claim 5, further comprising transmitting a request to the device requesting that the device transmit the second indication upon entering the geographical-based fence.

11. The method of claim 5, wherein the threshold TOT is based at least in part on at least one of a time of day or the one or more items.

12. The method of claim 5, wherein the one or more actions comprises:
causing a first associate at the physical location to locate the one or more items within the physical location; or
causing at least one of the first associate or a second associate to transport the one or more items to a pick up location at which the customer is to obtain the one or more items.

13. The method of claim 5, further comprising:
receiving the tracking information at a first time;
receiving, at a second time that is after the first time, second tracking information of the device within the geographical-based fence; and
determining an updated ETA and an updated TOT based on the second tracking information.

14. A computer-readable storage medium having computer executable instructions which, when executed by a processor, cause the processor to perform acts comprising:
setting a geographical-based fence around a physical location at which one or more items are to be picked up by a customer;
receiving an indication that the customer entered the geographical-based fence;
receiving, based at least in part on the customer entering the geographical-based fence, information associated with a location of a device of the customer within the geographical-based fence;
causing a first action to be performed;
determining, based at least in part on the information, a time of travel (TOT) from the location of the device to the physical location; and
causing a second action to be performed based at least in part on the TOT.

15. The computer-readable storage medium of claim 14, wherein the acts further comprise determining that the TOT is within a time-based fence around the physical location, and wherein causing the second action to be performed is further based at least in part on determining that the TOT is within the time-based fence.

16. The computer-readable storage medium of claim 14, wherein the acts further comprise:
determining, at a first time, the TOT;
determining a second time-based fence around the physical location;
determining, at a second time that is after the first time, a second TOT from a second location of device to the physical location; and
causing a third action to be performed based at least in part on determining that the second TOT is within the second time-based fence.

17. The computer-readable storage medium of claim 16, wherein:
the first action comprises at least one of:
determining an estimated time of arrival (ETA) of the customer at the physical location;
determining the TOT; or
causing the one or more items to be located within the physical location;
the second action comprises at least one of:
causing the one or more items to be located within the physical location; or
causing an associate of the physical location to transport the one or more items to a pick up location at which the customer is to obtain the one or more items; and
the third action comprises at least one of:
causing the associate of the physical location to transport the one or more items to the pick up location at which the customer is to obtain the one or more items; or
causing the associate to transport the one or more items to a holding area at the physical location to await arrival of the customer.

18. The computer-readable storage medium of claim 14, wherein the information associated with the location of the device comprises at least one of:
location coordinates of the device;
an accuracy of the location coordinates of the device;
a speed of the device;
an acceleration of the device; or
a bearing of the device.

19. The computer-readable storage medium of claim 14, wherein the acts further comprise:
receiving the information at a first time;
receiving, at a second time that is after the first time, second information associated with an updated location of the device within the geographical-based fence;
determining, based at least in part on the second information, an updated TOT from the updated location of the customer to the physical location; and
based on the updated TOT, at least one of:
causing the second action to be performed;
preventing the second action from being performed; or
causing a third action to be performed.

20. The computer-readable storage medium of claim 14, wherein the acts further comprise:
continuously receiving, from the device and according to a predetermined schedule, updated information associated with updated locations of the device within the geographical-based fence;
continuously determining an updated TOT from the updated locations of the device to physical location; and
causing at least one of the second action or a third action to be performed is based at least in part on the updated TOT.
